(19) United States
(12) Patent Application Publication
(10) Pub. No.: US 2010/0100880 A1
(43) Pub. Date: Apr. 22, 2010

(54) VIRTUAL SYSTEM CONTROL METHOD AND APPARATUS

(75) Inventors: Soichi Shigeta, Kawasaki (JP); Yuji Imai, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/577,274

(22) Filed: Oct. 12, 2009

(30) Foreign Application Priority Data
Oct. 22, 2008 (JP) 2008-271576

(51) Int. Cl. G06F 9/455

(52) U.S. Cl. 718/1

(57) ABSTRACT

A virtual system control apparatus includes a configuration information storage device that stores configuration information for operational systems of virtual systems; a first virtual machine image storage device that stores virtual machine images for the operational systems of the virtual systems; a configuration change information storage device that stores configuration change information that represents configuration information concerning difference between the operational system and a test system of the virtual system; a second virtual machine image storage device that stores virtual machine images for the virtual machine relating to the difference; and a controller. Thus, by adopting data configuration of the operational system and the test system, it becomes possible to easily and smoothly switch the virtual system between the operational system and the test system.

### CROSS-REFERENCE TO RELATED APPLICATIONS

This application is based upon and claims the benefit of priority of the prior Japanese Patent Application No. 2008-271576, filed on Oct. 22, 2008, the entire contents of which are incorporated herein by reference.

### FIELD

This technique relates to a technique that enables to switch a virtual system between an operational system and a test system in one physical server pool including plural physical servers.

### BACKGROUND

In an environment in which plural virtual machines are deployed on physical servers and a virtualized system is constructed by causing such plural virtual machines to cooperate each other through a network, it is desired that a test for the virtualized system (hereinafter, also called “virtual system”) is effectively and efficiently carried out. At present, the development and test of such a virtual system are carried out by physically preparing an environment for the development and test. Typically, the scale of the environment for the development and test is smaller than an actually operational environment in which the virtual system will be actually operated, and the environment for the development and test is separated from the actually operational environment.

The physical separation between the actually operational environment and the environment for the development and test allows to exclude the danger of harmfully influencing the actually operational system by the system in the development and test (e.g. the trouble of the system in the development and test causes the stop or mis-operation of the actually operational system). However, there is a case where the actually operational environment is different from the environment for the development and test. For instance, the hardwares of the physical servers may be different, the software versions of the Operating Systems (OS) or libraries may be different. Therefore, a lot of problems occur such as troubles, which were not observed in the environment for the development and test, are discovered after the operation of the system in the actually operational environment started, and troubles occur due to the setting mistakes when porting the virtual system from the environment for the development and test to the actually operational environment.

Incidentally, various conventional arts exist for the virtual system. However, no technique pays attention to the aforementioned problem.

Recently, non-stop of the business service becomes a very important system requirement. Namely, necessity and importance increase in which the test after the configuration change (e.g. change of the number of virtual machines that cooperate each other, and application of the security patch) of the system is conducted without stopping the business service being actually operated, and the system after the configuration change is promptly made to be actually operated. However, at present, such a requirement is not satisfied.

Namely, there is no technique to easily convert the virtual system from the test system to the operational system in one physical server pool including plural physical servers.

### SUMMARY

This virtual system control method includes: receiving a deployment request for requesting to deploy a test system of a specific virtual system in a physical server pool in which operational and test virtual systems can be deployed; activating a virtual machine necessary for the operational system of the specific virtual system in the physical server pool by using first server configuration data in configuration information for the operational system of the specific virtual system and a first virtual machine image for the operational system of the specific virtual system; activating a virtual machine to be added to the operational system of the specific virtual system in the physical server pool by using second server configuration data in configuration change information representing configuration information concerning difference between the operational system and the test system of the specific virtual system and a second virtual machine image for the virtual machine relating to the difference; and carrying out a setting of a network connecting the activated virtual machines according to network configuration data generated by merging first network setting information between the virtual machines in the configuration information for the operational system of the specific virtual system and second network setting information that represents difference on the network between the operational system and the test system of the specific virtual system, and is included in the configuration change information.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a schematic drawing depicting a premise in an embodiment of this technique;

FIG. 2 is a schematic drawing depicting the premise in the embodiment of this technique;

FIG. 3 is a system outline diagram in the embodiment of this technique;

FIG. 4 is a system configuration diagram of a virtual system deployment and test control apparatus in the embodiment of this technique;

FIG. 5 is a diagram depicting an example of a system management table;

FIG. 6 is a diagram depicting an example of data stored in a system logical configuration storage;

FIG. 7 is a diagram depicting an example of data stored in a logical configuration definition file;

FIG. 8 is a diagram schematically depicting data stored in a VM image repository;

FIG. 9 is a diagram depicting an example of data stored in a system deployment state table;

FIG. 10 is a diagram depicting an example of data stored in system logical configuration change storage;

FIG. 11 is a diagram depicting an example of data stored in a logical configuration change definition file;

FIG. 12 is a diagram schematically depicting data stored in a test driver VM image repository;

FIG. 13 is a diagram depicting an example of data stored in a test item storage;

FIG. 14 is a diagram depicting a processing flow in the embodiment;

FIG. 15 is a diagram depicting a processing flow in the embodiment;

FIG. 16 is a diagram depicting a processing flow in the embodiment;

FIG. 17 is a diagram depicting a processing flow in the embodiment;

FIG. 18 is a diagram depicting a processing flow in the embodiment;

FIG. 19 is a diagram depicting a processing flow in the embodiment;

FIG. 20 is a diagram depicting a processing flow in the embodiment;

FIG. 21 is a diagram depicting a processing flow in the embodiment;

FIG. 22 is a diagram depicting a processing flow in the embodiment; and

FIG. 23 is a functional block diagram of a computer.

### DESCRIPTION OF EMBODIMENTS

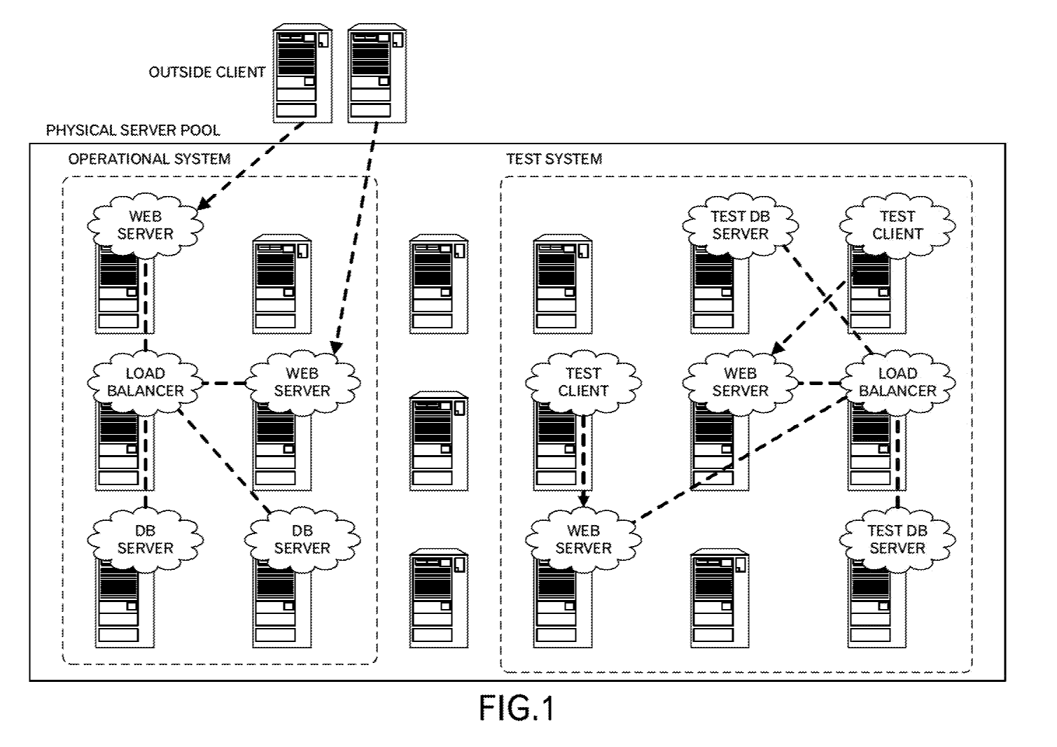

In this embodiment of this technique, as depicted in FIG. 1, the operational system of the virtual system and the test system of the virtual system can exist together in one physical server pool including plural physical servers. Namely, in this embodiment, which is different from the conventional arts, the test system of the virtual system is not activated in another physical server pool, and the test system is also activated in the physical server pool in which the operational system can also be activated. As an example of FIG. 1, the test system including two Web servers, two test DB servers, two test clients and one load balancer exists together with the operational system including two Web servers, two DB servers and one load balancer. Incidentally, plural virtual machines may be activated on one physical server.

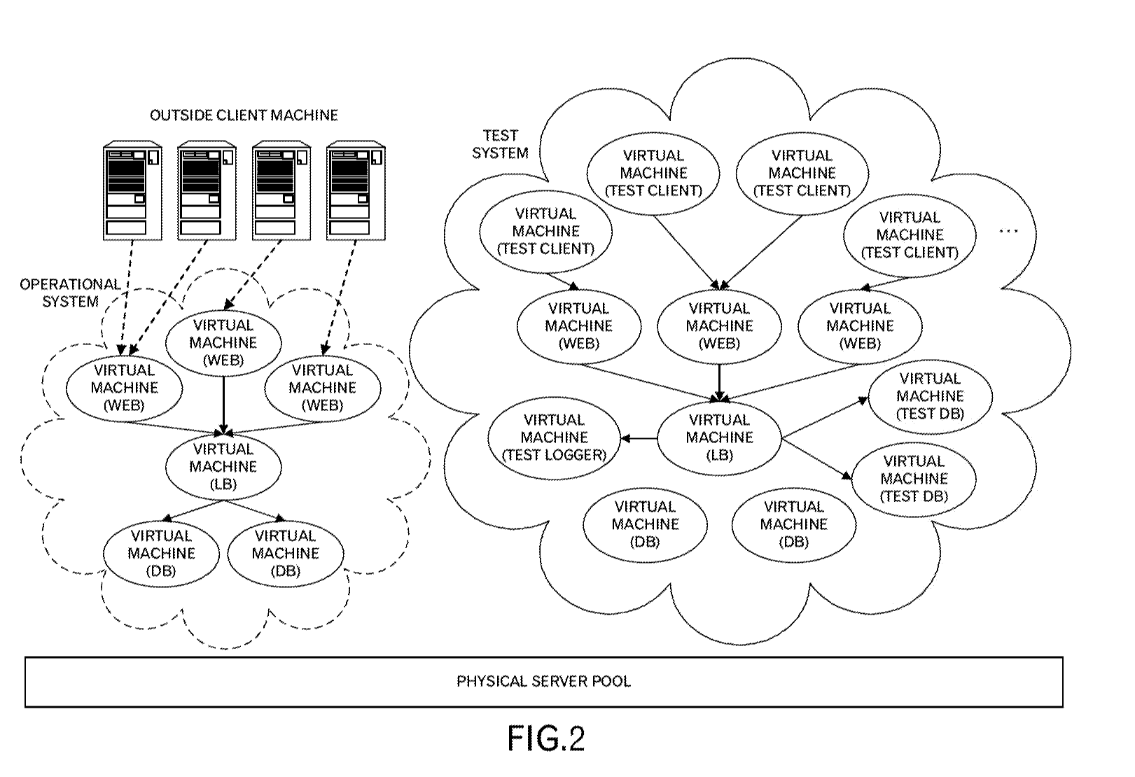

Furthermore, in this embodiment of this technique, not only the operational system and the test system of the virtual system simply exist together, but also the configuration of the test system is contrived as depicted in FIG. 2. Namely, the operational system of the virtual machine includes three virtual machines for the Web server, one virtual machine for the load balancer (LB) and two virtual machines for the DB server. Then, the test system of the virtual machine includes four virtual machines for the test client, one virtual machine for the test logger and two virtual machines for the test DB in addition to the same virtual machines as the operational system.

At this time, although two virtual machines for the DB server, which are included in the operational system, are activated, they are not used for the test and two virtual machines for the test DB are used on behalf of those. Thus, the virtual machines for the test system are activated additionally to the virtual machines of the operational system. However, the network configuration of the test system, which is represented by arrows, is different from that of the operational system, and the network configuration for the test is adopted.

Thus, by making the virtual machine configuration of the test system in a form that the additional virtual machines are added to the virtual machine configuration of the operational system, the problem does not easily occur when converting the virtual system from the test system to the operational system. Namely, the operational system is not defined separately from the test system, but the test system is defined only by the difference with the operational system. Therefore, when defining and constructing the test system, the virtual machine configuration of the operational system has already been confirmed. Therefore, when the test for the test system is conducted and there is no problem, it is possible to deploy and operate the operational system soon. In addition, because the system conversion in the same physical server pool is carried out, any problem due to the difference of the configuration in the physical server included in the physical server pool does not occur. Namely, the switching from the test system to the operational system can be carried out smoothly.

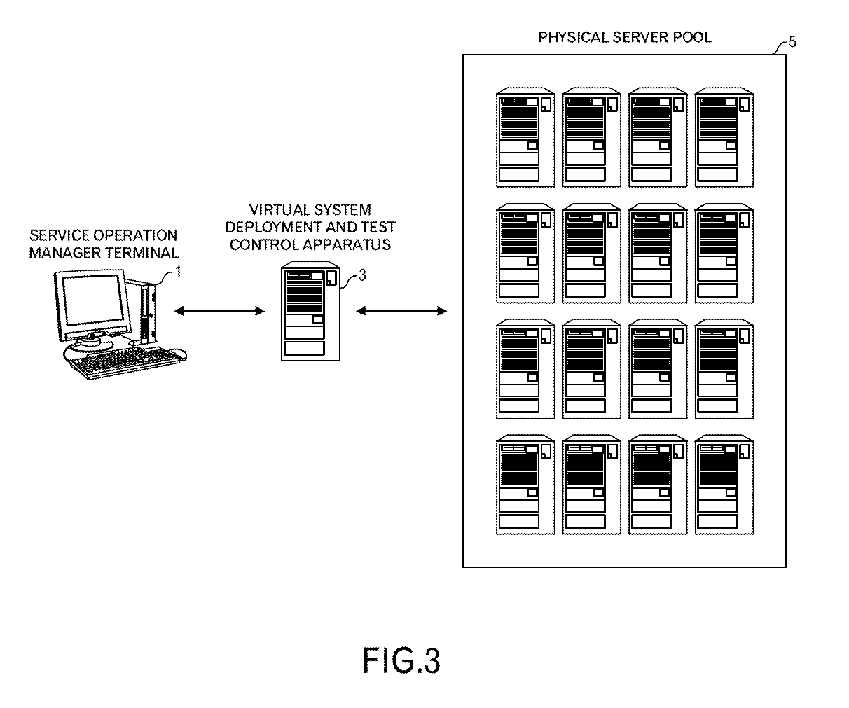

Based on the aforementioned outline of this embodiment, FIG. 3 depicts a system outline in this embodiment. A service operation manager terminal 1 is connected with a virtual system deployment and test control apparatus 3. Furthermore, the virtual system deployment and test control apparatus 3 is connected to a physical server pool 5 including plural physical servers through a network.

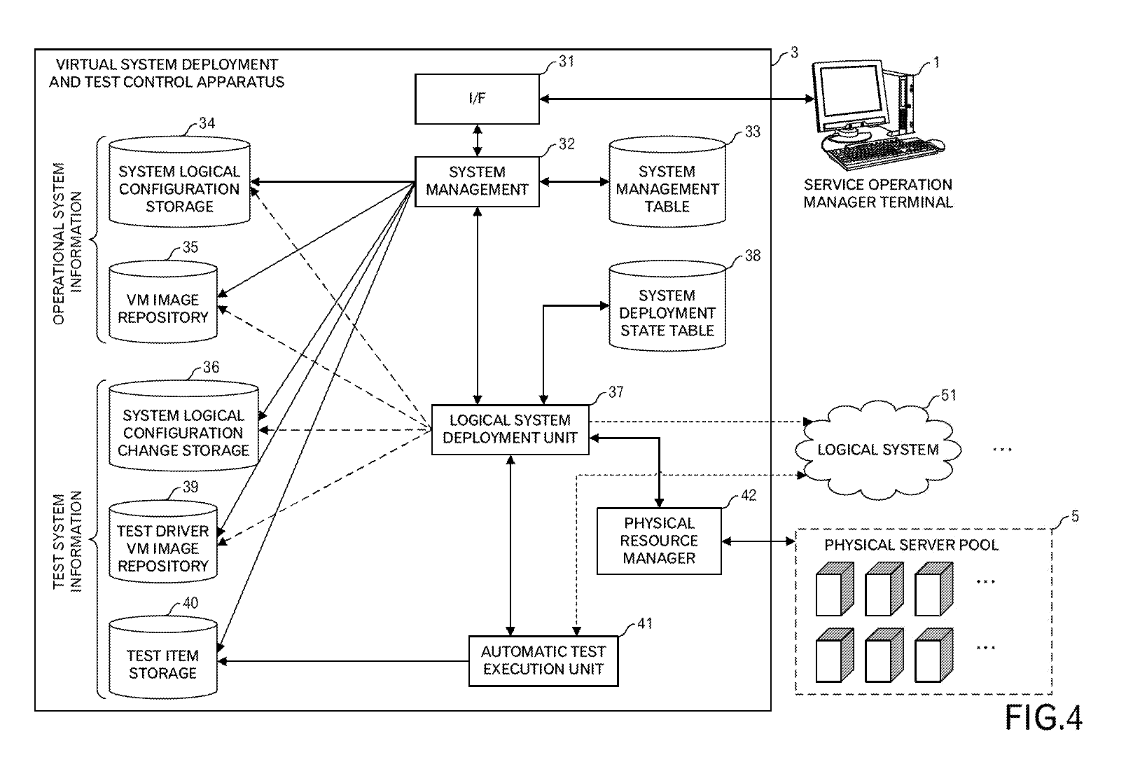

FIG. 4 depicts the details of the virtual system deployment and test control apparatus 3 that carries out a main processing in this embodiment. The virtual system deployment and test control apparatus 3 has an I/F 31 that is an interface with the service operation manager terminal 1, a system manager 32, a system logical configuration storage 34, a Virtual Machine (VM) image repository 35, a logical system deployment unit 37, a system deployment state table 38, a system logical configuration change storage 36, a test driver VM image repository 39, an automatic test execution unit 41, a test item storage 40 and a physical resource manager 42. Incidentally, the system logical configuration storage 34 and VM image repository 35 store operational system information. In addition, the system logical configuration change storage 36, the test driver VM image repository 39 and the test item storage 40 store test system information.

The I/F 31 outputs data received from the service operation manager terminal 1 to the system manager 32, and outputs data received from the system manager 32 to the service operation manager terminal 1. The system manager 32 carries out data registration and data deletion to the system logical configuration storage 34, the VM image repository 35, the system logical configuration change storage 36, the test driver VM image repository 39 and the test item storage 40 according to the instructions from the service operation manager terminal 1. In addition, the system manager 32 manages data registered in the aforementioned data storage units by using the system management table 33. Furthermore, the system manager 32 cooperates with the logical system deployment unit 37.

The logical system deployment unit 37 manages the system deployment state table 38, and deploys a logical system 51 on the physical machines secured in the physical server pool 5 by using data stored in the system logical configuration storage 34, the VM image repository 35, the system logical configuration change storage 36 and the test driver VM image repository 39, and also carries out a processing to dismantle the virtual machine and the like. The logical system deployment unit 37 cooperates with the physical resource manager 42 and the automatic test execution unit 41.

The physical resource manager 42 carries out a processing to secure or release the physical servers on the physical server pool 5 according to instructions from the logical system deployment unit 37. Incidentally, the processing content of the physical resource manager 42 is the same as the conventional arts.

Furthermore, the automatic execution unit 41 executes the tests for the test items registered in the test item storage 40 against the logical system 51 according to instructions from the logical system deployment unit 37, and outputs test results to the logical system deployment unit 37. Incidentally, the processing content of the automatic test execution unit 41 is the same as the conventional arts.

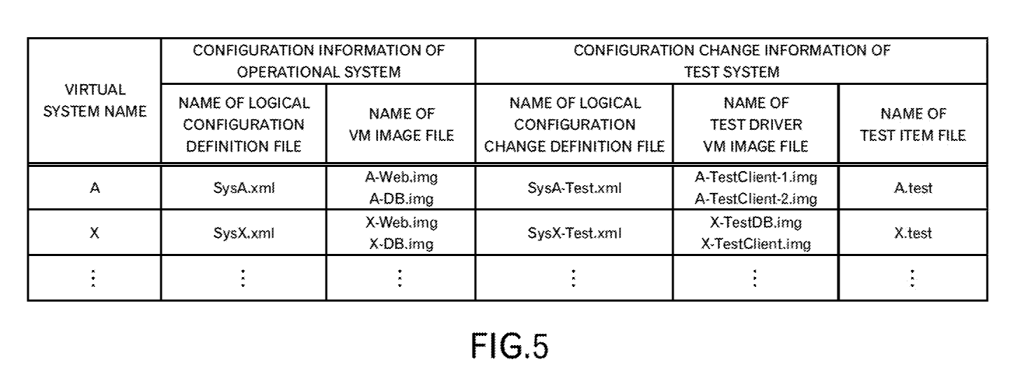

An example of data stored in the system management table 33 is depicted in FIG. 5. In the system management table 33, for each virtual system, file names of a logical configuration definition file and VM image files, which are used as configuration information of the operational system, are registered, and file names of a logical configuration change definition file and test driver VM image files, which are used as configuration change information of the test system, are registered. Incidentally, file names of test item files used for the test of the test system are also registered for each virtual system.

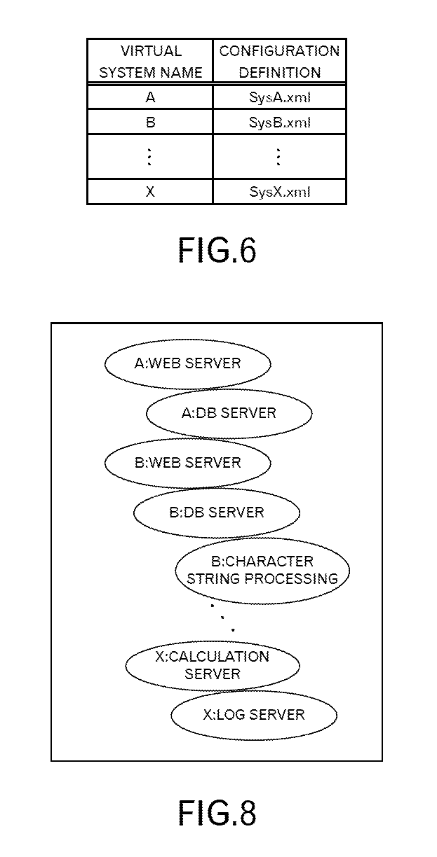

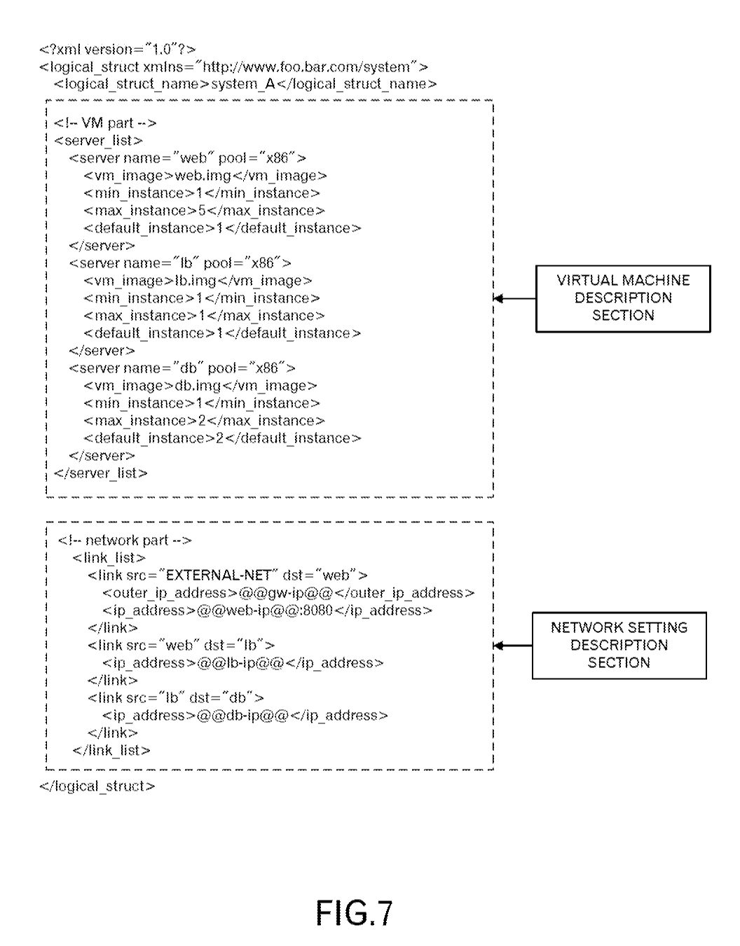

An example of data stored in the system logical configuration storage 34 is depicted in FIG. 6. In the system logical configuration storage 34, for each virtual system, logical configuration definition files for the operational system are registered. The logical configuration definition file includes data depicted in FIG. 7, for example. The logical configuration definition file depicted in FIG. 7 is described in XML, and includes a virtual machine description section and a network setting description section. The virtual machine description section includes a list of servers, and for each server, a name (e.g. Web, lb, db or the like) of the server, a VM image file name (e.g. Web.img, lb.img, db.img or the like), the minimum number of instances, the maximum number of instances, and the default number of instances are registered. Incidentally, an attribute pool=“x86” represents a processor type of the physical server to be secured. In addition, the network setting description section includes a list of links, and for each link, a source node name (e.g. EXTERNAL-NET or Web), a destination node name (e.g. lb (load balancer) or db), and an IP address are registered. Incidentally, when the source node name represents the outside network, the IP address of a gateway, which is a connection point with the outside network, is also registered.

In addition, a schematic diagram of data stored in the VM image repository 35 is depicted in FIG. 8. In the VM image repository 35, an image file of the image file name registered in the column of the name of the VM image file in the system management table 33 is registered. In addition, all of the image files for the virtual machines listed in the logical configuration definition file are registered. In an example of FIG. 8, for example, “A: Web server” represents an image file for the Web sever of the virtual system A.

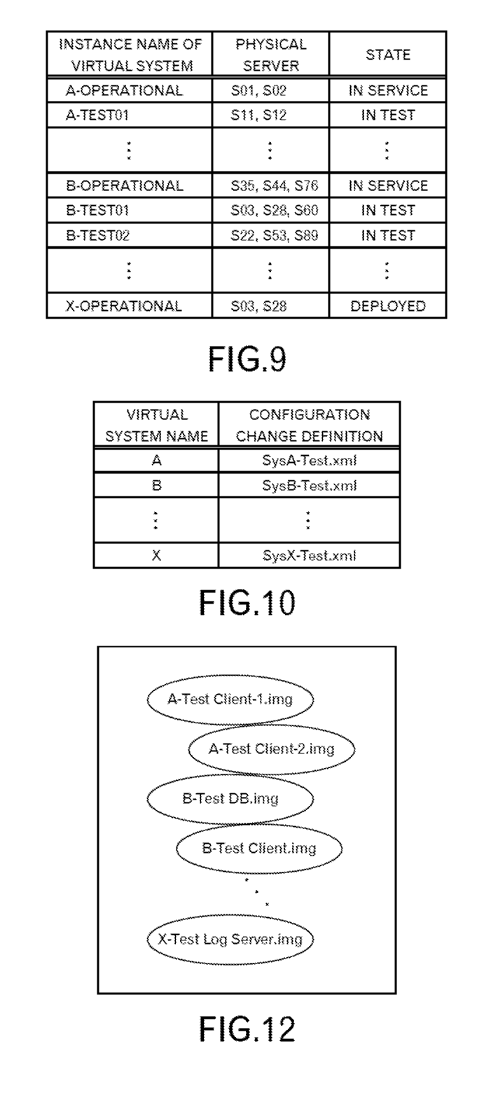

In addition, an example of data stored in the system deployment state table 38 managed by the logical system deployment unit 37 is depicted in FIG. 9. In the example of FIG. 9, an instance name (“a type of the virtual system”+“an instance name” (e.g. operational or test+number)) of the virtual system managed by the logical system deployment unit 37, an identifier of the secured physical server and a state (e.g. in service, in test, deployed or during dismantling) are registered.

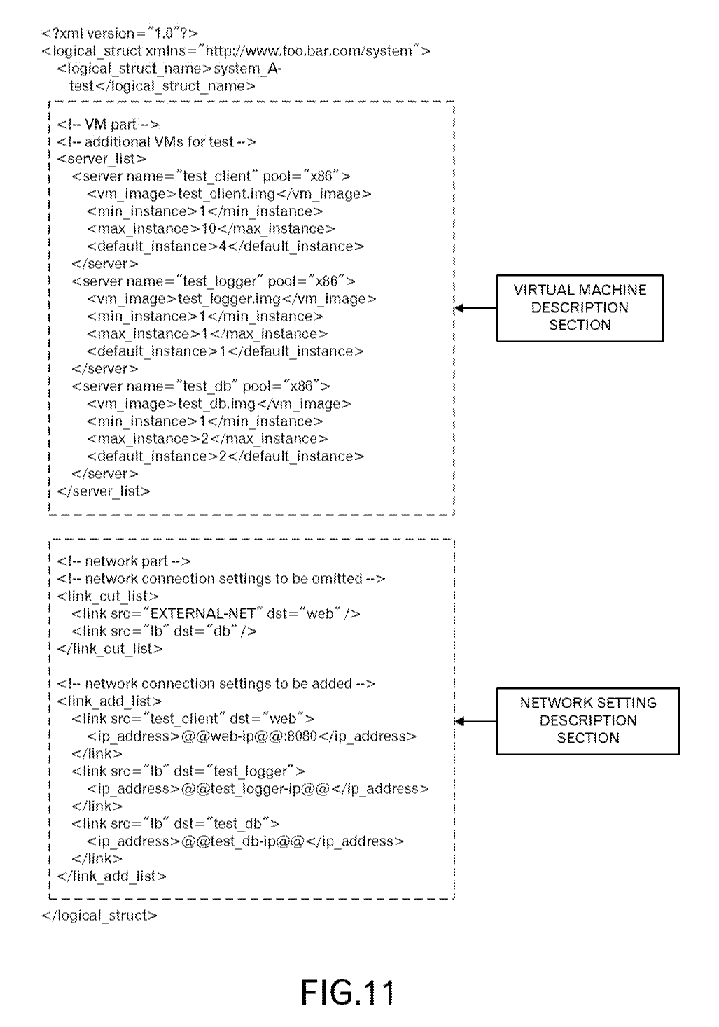

Next, an example of data stored in the system logical configuration change storage 36 is depicted in FIG. 10. The system logical configuration change storage 36 stores, for each virtual system, a logical configuration change definition file for the test system. The logical configuration change definition file includes data as depicted in FIG. 11, for example. The logical configuration change definition file includes a virtual machine description section in which the virtual machines to be deployed and activated in addition to the virtual machines listed in the virtual machine description section in the logical configuration definition file are listed, and a network setting description section including links to be deleted and links to be added among the links listed in the network setting description section of the logical configuration definition file. In the logical configuration change definition file, the description method of the virtual machine description section is the same as the logical configuration definition file. On the other hand, as for the network setting description section, points different from the logical configuration definition file are as follows: a cut list for links to be deleted and an add list for links to be added are separated, and only the link type to be cut is designated in the cut list. However, the description method of the add list is the same as the network setting description section in the logical configuration definition file.

In addition, data stored in the test driver VM image repository 39 is schematically depicted in FIG. 12. The test driver VM image repository 39 stores images files whose file name is registered in the column of the name of the test driver VM image file in the system management table 33. In addition, all image files for the virtual machines listed in the logical configuration change definition file are registered.

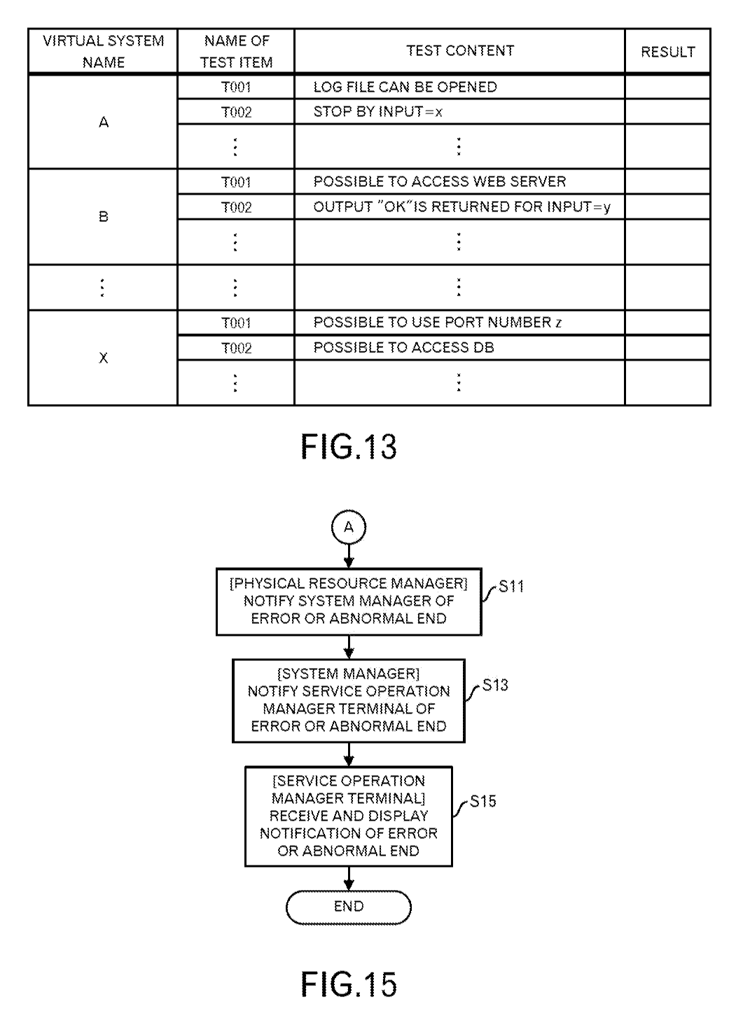

Furthermore, data as depicted in FIG. 13 is registered in the test item storage 40. In an example of FIG. 13, a table stores, for each of the virtual systems, a test item name and a test content. Although the test data for all virtual machines is depicted in FIG. 13 as the table, it is registered for each of the virtual machines as the test item file. The success or failure of the test is registered when the test has been carried out. However, because the test result is transmitted by the automatic test execution unit 41 through the system manager 32 and the I/F 31 to the service operation manager terminal 1, the test result may not be held in the test item storage 40.

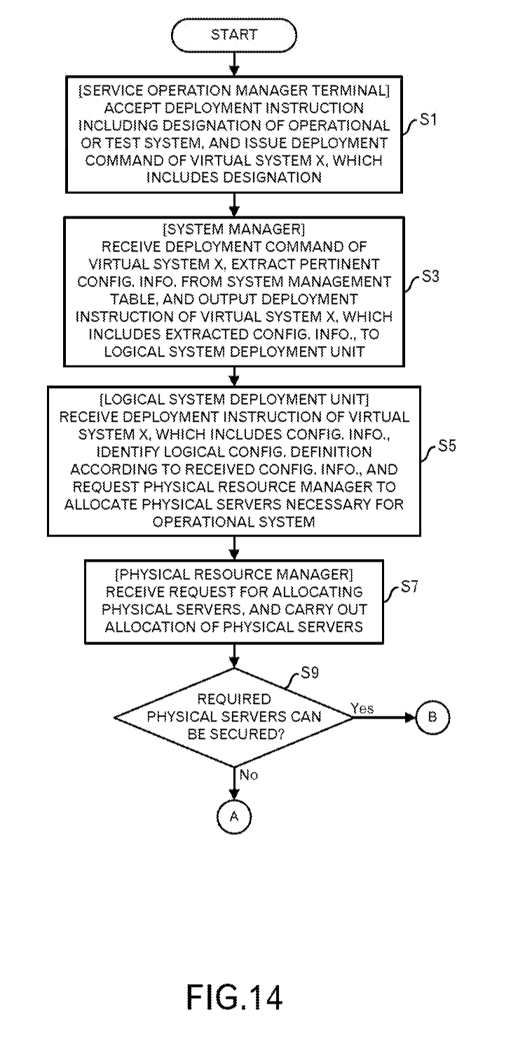

Next, a processing content of the system depicted in FIG. 3 will be explained by using FIGS. 14 to 22. First, when the service operation manager inputs a deployment instruction of a specific virtual system X, which includes designation of the operational system or test system, the service operation manager terminal 1 accepts the deployment instruction of the specific virtual system X, which includes the designation of the operational system or test system, and issues to the virtual system deployment and test control apparatus 3, a deployment command of the virtual system X, which includes the designation of the operational system or test system (step Si). When the I/F 31 of the virtual system deployment and test control apparatus 3 receives the deployment command of the virtual system X, which includes the designation of the operational system or test system, the I/F 31 outputs the deployment command to the system manager 32. The system manager 32 receives the deployment command of the virtual system X, which includes the aforementioned designation, extracts configuration information pertinent to this deployment command, and outputs a deployment instruction of the virtual system X, which includes the extracted configuration information, to the logical system deployment unit 37 (step S3). In a case of the deployment of the operational system of the virtual system X, the system manager 32 extracts, as the configuration information, the file name of the logical configuration definition file for the virtual system X and the file name of the VM image file from the system management table 33, and outputs the extracted data to the logical system deployment unit 37. On the other hand, in a case of the deployment of the test system of the virtual system X, the system manager 32 extracts, as the configuration information, the file name of the logical configuration definition file for the virtual system X, the file name of the VM image file, the file name of the logical configuration change definition file and the file name of the test driver VM image file from the system management table 33, and output the extracted data to the logical system deployment 37.

The logical system deployment unit 37 receives the deployment instruction of the virtual system X, which includes the configuration information, from the system manager 32, identifies the logical configuration definition file in the system logical configuration storage 34 according to the received configuration information, and requests the physical resource manager 42 to allocate the physical servers necessary for the operational system according to the virtual machine description section in the logical configuration definition file (step S5). Because the logical configuration definition file in FIG. 7 defines the default number of Web servers is “1”, the default number of load balancers is “1” and the default number of DB servers is “2”, the allocation of the total four physical servers are requested. Incidentally, the logical system deployment unit 37 adds a record relating to the received deployment instruction in the system deployment state table 38. For example, in case of the deployment of the test system of the virtual system X, a record including the instance name “X-test01” of the virtual system, “undecided” for the physical server and “deployed” for the state is added.

The physical resource manager 42 receives the request to allocate the physical servers from the logical system deployment unit 37, and carries out the allocation of the physical servers in the physical server pool 5 according to the request (step S7). Because this processing is the same as the conventional arts, no further explanation is made. Incidentally, when the necessary physical servers can be secured, the physical resource manager 42 notifies the logical system deployment unit 37 of information concerning which physical server was secured. The logical system deployment unit 37 registers the names of the secured physical servers into the pertinent record of the system deployment state table 38.

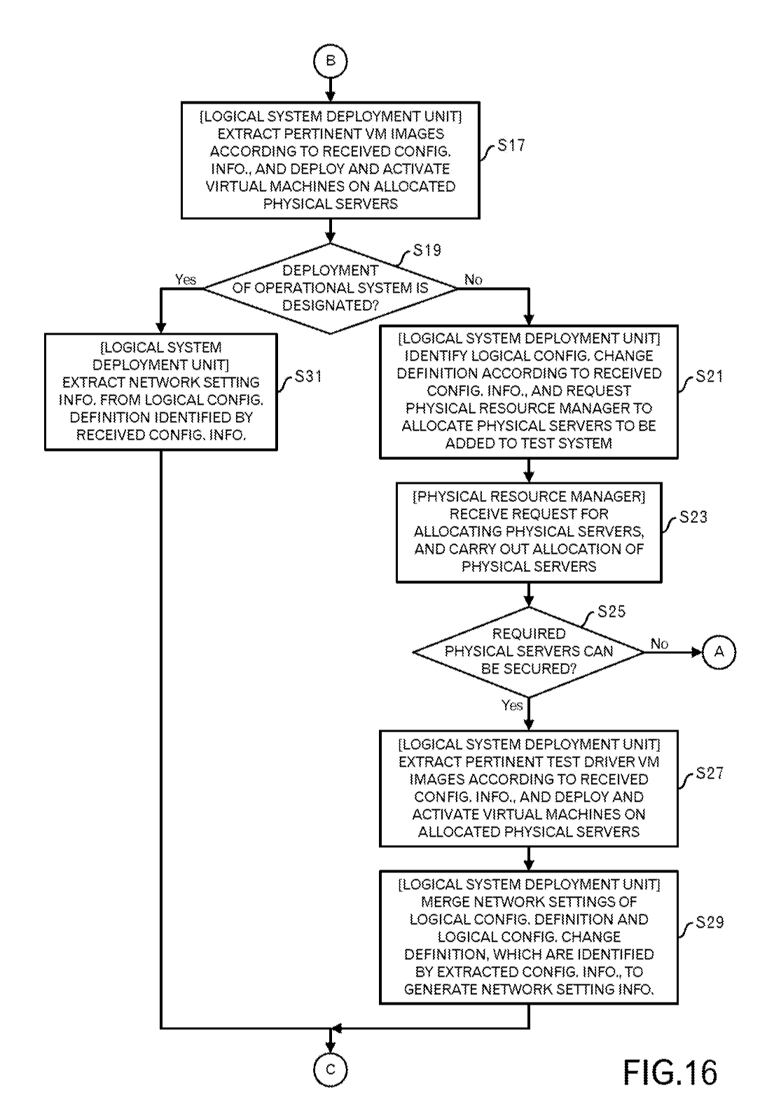

When the necessary physical servers could not be secured (step S9: No route), the processing shifts to a processing of FIG. 15 through a terminal A. On the other hand, when the necessary physical servers could be secured (step S9: Yes route), the processing shifts to a processing of FIG. 16 through a terminal B.

When the necessary physical servers could not be secured, the physical resource manager 42 notifies the system manager 32 of an error or abnormal end through the logical system deployment unit 37 (FIG. 15: step S11). Incidentally, the physical servers already secured for the request are released. When the logical system deployment unit 37 receives the error or abnormal end, the logical system deployment unit 37 transfers the notification to the system manager 32, and deletes the pertinent record in the system deployment state table 38. The system manager 32 notifies the service operation manager terminal 1 of the error or abnormal end through the I/F 31 (step S13). When the service operation manager terminal 1 receives the notification of the error or abnormal end from the virtual system deployment and test control apparatus 3, the service operation manager terminal 1 notifies the service operation manager by, for example, displaying the notification on the display device (step S15). Then, the processing is terminated.

On the other hand, when the necessary physical servers could be secured, the logical system deployment unit 37 extracts the pertinent VM image files from the VM image repository 35 according to the file names of the VM image files, which are included in the received configuration information, and deploys and activates the virtual machines by loading the VM images onto the allocated physical servers (step S17). Thus, when the operational system is deployed, the activation of the necessary virtual machines is completed. On the other hand, in a case of the deployment of the test system, the activation of a portion of the virtual machines is completed.

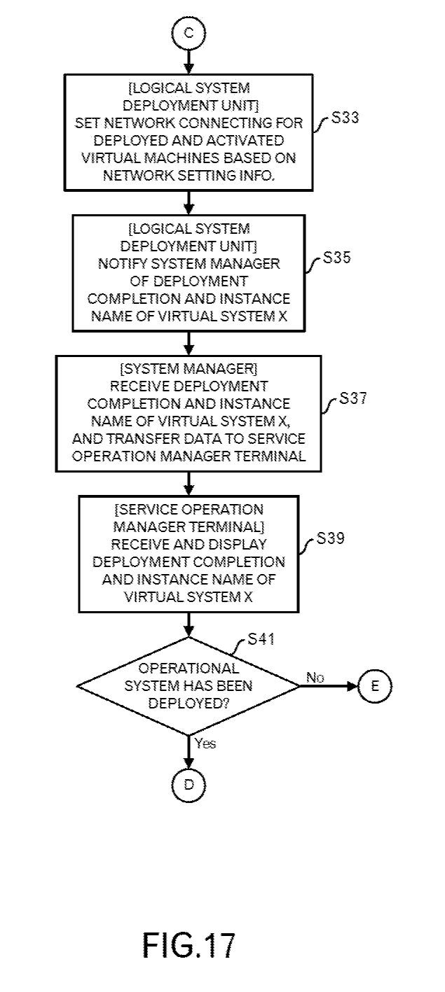

Then, when the operational system is deployed (step S19: Yes route), the logical system deployment unit 37 extracts the network setting information (here, the network setting description section itself) from the logical configuration definition file identified by the received configuration information (step S31). After that, the processing shifts to a processing of FIG. 17 through a terminal C.

On the other hand, when the test system is deployed (step S19: No route), the logical system deployment unit 37 identifies the pertinent logical configuration change definition file in the system logical configuration change storage 36 according to the received configuration information, and requests the physical resource manager 42 to allocate the physical servers, which are additionally necessary for the test system and are defined in the virtual machine description section of the logical configuration change definition file (step S21). In the example of FIG. 11, it is requested to secure four test clients, one test logger and two test DB servers in the default setting.

When the physical resource manager 42 receives an additional allocation request of the physical servers from the logical system deployment unit 37, the physical resource manager 42 carries out the allocation of the physical servers in the physical server pool 5 according to the request (step S23). This processing is the same as the processing in the conventional arts. Therefore, the further explanation is omitted. Incidentally, when the necessary physical servers could be secured, the physical resource manager 42 notifies the logical system deployment unit 37 of information as to which of the physical servers could be secured. The logical system deployment unit 37 registers the names of the secured physical servers into the pertinent record of the system deployment state table 38.

Here, when the necessary physical servers could not be secured (step S25: No route), the test system cannot be constructed. Therefore, the processing shifts to the processing of FIG. 15 through the terminal A. On the other hand, when the necessary physical servers could be secured (step S25: Yes route), the logical system deployment unit 37 extracts the pertinent test driver VM image files from the test driver VM image repository 39 according to the file names of the test driver VM image files, which are included in the received configuration information, and deploys and activates the virtual machines by loading the test driver VM images onto the allocated physical servers (step S27).

Thus, when the test system is deployed, after the virtual machines of the operational system are deployed and activated, the virtual machines additionally necessary for the test system are deployed and activated. Therefore, at the stage when the test system can be deployed, the operational system has already been deployed. Therefore, when there is no problem in the test system, it is possible to convert the virtual system into the operational system soon.

Furthermore, the logical system deployment unit 37 merges the network setting description section of the logical configuration definition file and the network setting description section of the logical configuration change definition file, which are identified from the received configuration information to generate the network setting information for the test system, and stores the generated network setting information into a storage device such as a main memory (step S29). In the example of FIG. 7, (1a) a link between the outside network and the Web server, (2a) a link between the Web server and the load balancer lb and (3a) a link between the load balancer lb and the DB server are defined. In addition, in the example of FIG. 11, as the cut list, (1b) a link between the outside network and the Web server and (2b) a link between the load balancer lb and the DB server are defined, and as the add list, (1c) a link between the test client and the Web server, (2c) a link between the load balancer lb and the test logger and (3c) a link between the load balancer lb and the test DB server are defined. Therefore, the link (1a) is deleted by the link (1b), and the link (3a) is deleted by the link (2b). Namely, the remaining links are the links (2a), (1c), (2c) and (3c). Those links are the links included in the network setting information. The processing shifts to the processing of FIG. 17 through the terminal C.

Thus, because there is a case where the test system cannot be constructed only by simply adding the links to the operational system as for the network configuration, the aforementioned merge processing is carried out in order to resolve such difference. However, when the network setting description section of the logical configuration file and the network setting description section of the logical configuration change definition file are not conformably defined each other, the appropriate test system cannot be constructed. Namely, when there is an unappropriate portion in the network setting description section of the logical configuration file or the network setting description section of the logical configuration change definition file, the test for the test system cannot be conducted. Therefore, when the test for the test system can be successfully conducted, the possibility that the operational system successfully works becomes much higher.

Shifting to the explanation of the processing in FIG. 17, the logical system deployment unit 37 carries out settings of the network for the deployed and activated virtual machines based on the network setting information generated at the step S31 or S29 (step S33). By doing so, the target logical system 51 has been constructed on the physical server pool 5. Therefore, the state of the pertinent record in the system deployment state table 38 is changed to the “deployed”, for example. Incidentally, the details of this processing is the same as the conventional arts. Therefore, the further explanation is omitted.

Then, the logical system deployment unit 37 notifies the system manager 32 of the deployment completion and the instance name of the virtual system X (step S35). The system manager 32 receives the notification of the deployment completion and instance name of the virtual system X from the logical system deployment unit 37, and transfers the notification to the service operation manager terminal 1 through the I/F 31 (step S37). The service operation manager terminal 1 receives the notification of the deployment completion and the instance name of the virtual system X from the virtual system deployment and test control apparatus 3, and displays the notification on a display device (step S39). Thus, the service operation manager can grasp that the preparation has been completed.

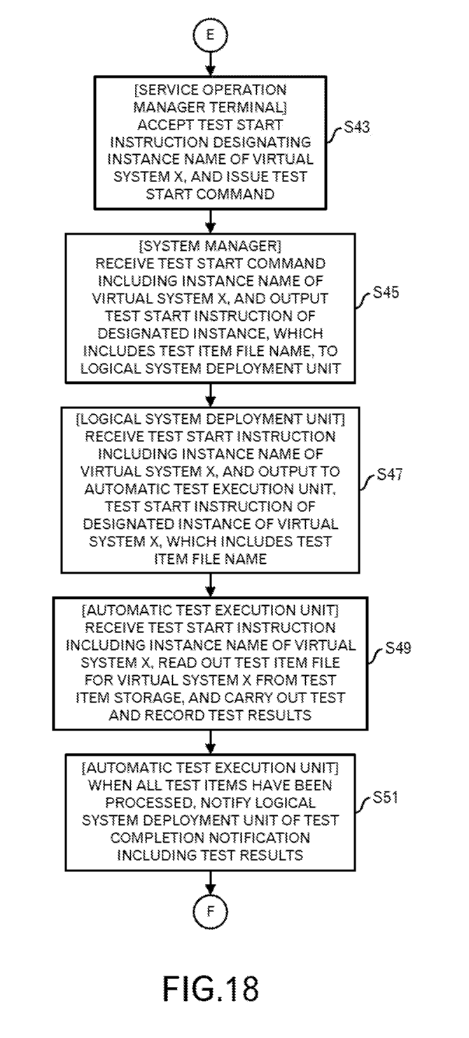

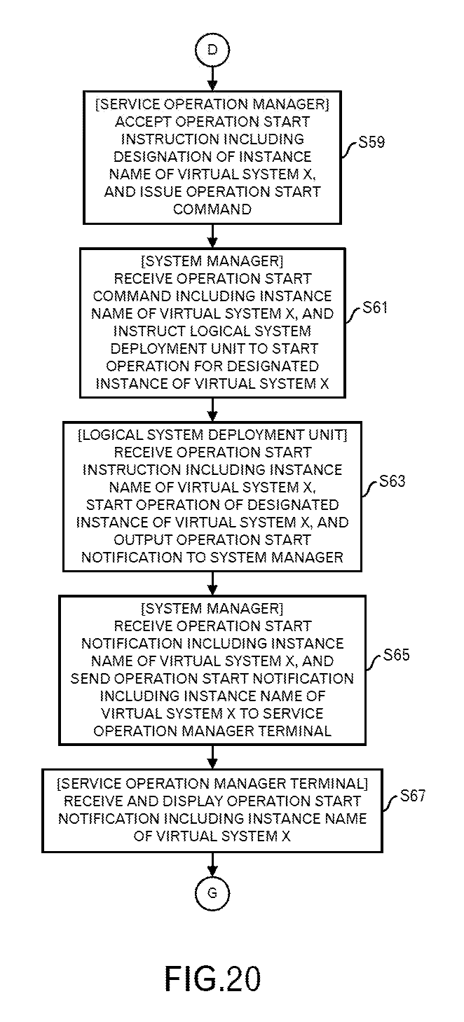

Here, in a case of the deployment completion of the operational system (step S41: Yes route), the processing shifts to a processing of FIG. 20 through a terminal D. On the other hand, in a case of the deployment completion of the test system (step S41: No route), the processing shifts to a processing of FIG. 18 through a terminal E.

In the deployment completion of the test system, the processing shifts to the processing of FIG. 18, the service operation manager inputs a test start instruction, which designates the instance name of the virtual system X, into the service operation manager terminal 1. The service operation manager terminal 1 accepts the test start instruction, and issues a test start command to the virtual system deployment and test control apparatus 3 (step S43).

The system manager 32 of the virtual system deployment and test control apparatus 3 receives the test start command including the instance name of the virtual system X through the I/F 31, identifies the file name of the test item file for the virtual system X from the system management table 33, and outputs to the logical system deployment unit 37, a test start instruction for the designated instance of the virtual system X, which includes the file name of the test item file (step S45).

The logical system deployment unit 37 receives the test start instruction including the file name of the test item file and the instance name of the virtual system X, and outputs to the automatic test execution unit 41, a test start instruction for the designated instance of the virtual system X, which includes the file name of the test item file (step S47). The automatic execution unit 41 receives the test start instruction including the file name of the test item file and the instance name of the virtual system X, receives the test item file of the designated file name from the test item storage 40, carries out the test according to the test item file, and stores the test result into the storage device such as the main memory (step S49). The performance itself of the test according to the test item file is the same as the conventional arts. Therefore, the further explanation is omitted. Incidentally, in the system deployment state table 38, the state in the pertinent record is changed to “in test”.

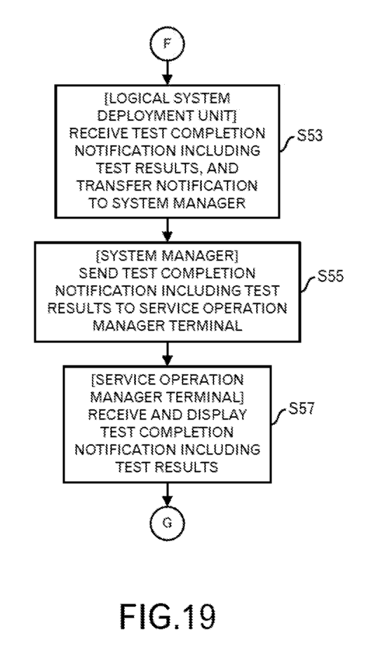

Then, the automatic test execution unit 41 outputs to the logical system deployment unit 37, a test completion notification including the test result, when all of the test items have been processed (step S51). The processing shifts to a processing of FIG. 19 through a terminal F.

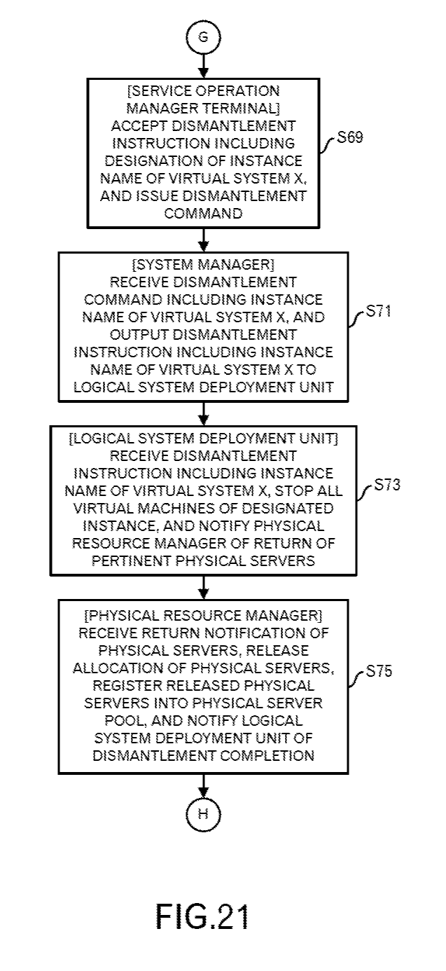

The logical system deployment unit 37 receives the test completion notification including the test result from the automatic test execution unit 41, and transfers the notification to the system manager 32 (step S53). The system manager 32 receives the test completion notification including the test result from the logical system deployment unit 37, and transmits the test completion notification including the test result through the I/F 31 to the service operation manager terminal 1 (step S55). The service operation manager terminal 1 receives the test completion notification including the test result from the virtual system deployment and test control apparatus 3, and displays the notification on the display device (step S57). Thus, the service operation manager can judges the test result and carries out the countermeasure. The processing shifts to a processing of FIG. 21 through a terminal G.

Next, a processing in a case where the operational system has been deployed will be explained by using FIG. 20. The service operation manager inputs an operation start instruction, which designates the instance name of the virtual system X, to the service operation manager terminal 1. The service operation manager terminal 1 accepts the operation start instruction, which designates the instance name of the virtual system X, and issues an operation start command including the instance name of the virtual system X to the virtual system deployment and test control apparatus 3 (step S59). The system manager 32 of the virtual system deployment and test control apparatus 3 receives the operation start command including the instance name of the virtual system X from the service operation manager terminal 1, and instructs the logical system deployment unit 37 to start the operation for the designated instance of the virtual system X (step S61).

The logical system deployment unit 37 receives the operation start instruction including the instance name of the virtual system X, starts the operation of the designated instance of the virtual system X, and outputs an operation start notification including the instance name of the virtual system X (step S63). Incidentally, the processing itself for starting the operation of the virtual system is the same as the conventional arts. Therefore, no further explanation is carried out. For example, the activation of processes (e.g. httpd, ftpd or the like), which receive a processing request from the outside network, is carried out. In addition, in the system deployment state table 38, the state in the pertinent record is changed to “in service”.

The system manager 32 receives the operational start notification including the instance name of the virtual system X from the logical system deployment unit 37, and transmits the operation start notification including the instance name of the virtual system X to the service operation manager terminal 1 (step S65). The service operation manager terminal 1 receives the operation start notification including the instance name of the virtual system X from the virtual system deployment and test control apparatus 3, and displays the notification on the display device (step S67). Thus, the service operation manager can grasp that the operation of the virtual system X begins without any incident. The processing shifts to a processing of FIG. 21 through a terminal G.

For example, after the test, or when the operation is stopped due to the maintenance or the like, the processing of FIG. 21 is carried out. First, the service operation manager designates the instance name of the virtual system X to the service operation manager terminal 1, and inputs a dismantlement instruction. The service operation manager terminal 1 accepts the dismantlement instruction including designation of the instance name of the virtual system X, and issues a dismantlement command including the instance name of the virtual system X to the virtual system deployment and test control apparatus 3 (step S69).

The system manager 32 receives the dismantlement command including the instance name of the virtual system X from the service operation manager terminal 1, and outputs the dismantlement instruction including the instance name of the virtual system X to the logical system deployment unit 37 (step S71). The logical system deployment unit 37 receives the dismantlement instruction including the instance name of the virtual system X from the system manager 32, stops all of the virtual machines for the designated instance, identifies the physical servers for the designated instance of the virtual system X in the system deployment state table 38, and notifies the physical resource manager 42 of the return of the pertinent physical servers (step S73). The processing to stop the virtual machines is the same as the conventional arts. Therefore, any further explanation is not explained. Incidentally, here, in the system deployment state table 38, the state in the pertinent record is changed to “during dismantling”.

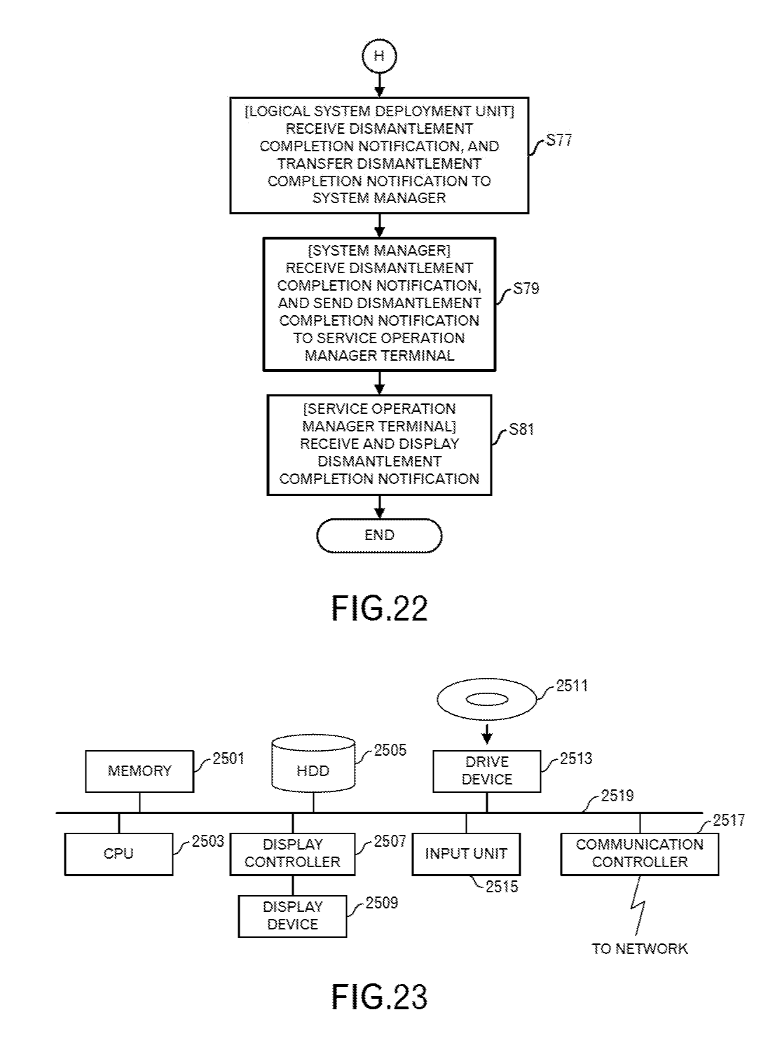

The physical resource manager 42 receives a return notification of the physical servers from the logical system deployment unit 37, releases the allocation of the physical servers, registers the released physical servers as free physical servers, to the physical server pool 5, and notifies the logical system deployment unit 37 of the dismantlement completion (step S75). The processing shifts to a processing of FIG. 22 through a terminal H.

The logical system deployment unit 37 receives the notification of the dismantlement completion from the physical resource manager 42, and transfers the notification of the dismantlement completion to the system manager 32 (step S77). Here, the logical system deployment unit 37 deletes the pertinent record in the system deployment state table 38. The system manager receives the notification of the dismantlement completion from the logical system deployment unit 37, and transmits the notification of the dismantlement completion to the service operation manager terminal 1 through the I/F 31 (step S79). The service operation manager terminal 1 receives the notification of the dismantlement completion from the virtual system deployment and test control apparatus 3, and displays the notification onto the display device (step S81). By doing so, the service operation manager can grasp the dismantlement completion.

As described above, by implementing this embodiment, the conversion from the test system to the operational system can be carried out smoothly. In addition, because the test system is constructed so as to resolve the difference with the operational system, it is possible to convert the virtual system to the operational system without any special setting if there is no problem in the test of the test system. Therefore, the setting mistake and the mis-operation of the service operation manager do not occur so many times. In addition, because the physical server pool is shared, the possibility that the trouble due to the fine difference between versions of the software in the physical servers can be avoided is high.

Although the embodiment of this technique was explained, this technique is not limited to this embodiment. For example, the data management method in the virtual system deployment and test control apparatus 3 is not limited to the method depicted in FIG. 4. In addition, the functional configuration in the virtual system deployment and test control apparatus 3 is not also limited to the block diagram of FIG. 4, and the program module configuration does not match with the actual program module configuration. For example, a controller in which the system manager 32, the logical system deployment unit 37 and the physical resource manager 42 are integrated into one module may be provided.

In addition, as long as the processing results of the processing flows are not changed, the order of the steps may be changed or the steps may be executed in parallel.

In addition, the physical server in the physical server pool, the service operation manager terminal 1 and the virtual system deployment and test control apparatus 3 are computer devices as shown in FIG. 23. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as shown in FIG. 23. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform necessary operations. Besides, intermediate processing data is stored in the memory 2501, and if necessary, it is stored in the HDD 2505. In this embodiment of this invention, the application program to realize the aforementioned functions is stored in the removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the necessary application programs systematically cooperate with each other, so that various functions as described above in details are realized.

This embodiment can be outlined as follows:

According to a first aspect of this embodiment, a virtual system control method includes: receiving a deployment request for requesting to deploy a test system of a specific virtual system in a physical server pool in which operational and test virtual systems can be deployed; activating a virtual machine necessary for the operational system of the specific virtual system in the physical server pool by using first server configuration data in configuration information for the operational system of the specific virtual system and a first virtual machine image for the operational system of the specific virtual system; activating a virtual machine to be added to the operational system of the specific virtual system in the physical server pool by using second server configuration data in configuration change information representing the configuration information concerning difference between the operational system and the test system of the specific virtual system and a second virtual machine image for the virtual machine relating to the difference; and setting a network connecting the activated virtual machines according to network configuration data generated by merging first network setting information between the virtual machines in the configuration information for the operational system of the specific virtual system and second network setting information that represents difference on the network between the operational system and the test system of the specific virtual system and is included in the configuration change information.

By defining the test system as the difference with the operational system after defining the operational system, it is possible to easily and promptly carry out conversion to the operational system when the test for the test system has been successfully completed.

In addition, the first aspect of this embodiment may further include: receiving a second deployment request for requesting to deploy the operational system of a second virtual system in the physical server pool; activating a second virtual machine necessary for the operational system of the second virtual system in the physical server pool, by using third server configuration data in second configuration information for the operational system of the second virtual system and a third virtual machine image for the operational system of the second virtual machine; and carrying out a setting of a network of the activated second virtual machine according to third network setting information in the second configuration information. Thus, when it is possible to deploy the test system, it is possible to easily carry out the deployment of the operational system of the virtual system.

Incidentally, the activating the virtual machine necessary for the operational system may include: identifying configuration information for the operational system of the specific virtual machine relating to the deployment request; securing first physical machines that can be deployed in the physical server pool according to the first server configuration data included in the identified configuration information; and identifying the first virtual machine images for the operational system of the specific virtual system, and activating the virtual machines on the secured first physical servers by using the identified first virtual machine images.

Furthermore, the activating the virtual machine to be added may include: identifying the configuration change definition information for the specific virtual system; securing second physical servers that can be deployed in the physical server pool according to the second server configuration data included in the configuration change definition information for the specific virtual system; and identifying the second virtual machine images for the virtual machines relating to the difference, and activating the virtual machines on the secured second physical servers by using the identified second virtual machine images.

In addition, the identifying the configuration information may include: identifying an identifier of the configuration information for the operational system of the specific virtual system relating to the deployment request from a first management table storing identifiers of the configuration information for the operational system of the virtual system and identifiers of the virtual machine images; and reading out the configuration information corresponding to the identified identifier of the configuration information from a configuration information storage device storing the configuration information for the operational system of the virtual system.

Furthermore, the activating the virtual machines on the secured first physical servers may include: identifying an identifier of the first virtual machine image for the operational system of the specific virtual system relating to the deployment request from the first management table; and reading out the first virtual machine image corresponding to the identified identifier of the virtual machine image from a first virtual machine image storage device storing the first virtual machine images for the operational system of the virtual system in association with the identifiers of the first virtual machine images.

Furthermore, the identifying the configuration change information for the specific virtual system may include: identifying an identifier of the configuration change information for the specific virtual system relating to the deployment request from a second management table storing identifiers of the configuration change information of the specific system and identifiers of the virtual machine images for the virtual machines relating to the difference between the operational system and the test system; and reading out the configuration change definition information corresponding to the identified identifier of the configuration change definition information from a configuration change information storage device storing the configuration change definition information of the virtual systems in association with the identifiers of the configuration change definition.

In addition, the identifying the second virtual machine images may include: identifying an identifier of the second virtual machine image for the specific virtual system relating to the deployment request from the second management server; and reading out the second virtual machine image corresponding to the identified identifier of the virtual machine image from a second virtual machine image storage device storing the second virtual machine images for the virtual machine relating to the difference between the operational system and the test system of the virtual system in association with the identifiers of the second virtual machine images.

Furthermore, the carrying out the setting of the network connecting the activated virtual machines may include: deleting, from the first network setting information included in the configuration information, items to be deleted among items in the network setting information included in the configuration change information, and adding to the first network setting information included in the configuration information, items to be added among items in the network configuration information included in the configuration change information. Thus, it becomes possible to carry out the network setting enabling the appropriate test.

According to a second aspect of this embodiment, a virtual system control apparatus includes a configuration information storage device that stores configuration information for operational systems of virtual systems; a first virtual machine image storage device that stores first virtual machine images for the operational systems of the virtual systems; a configuration change information storage device that stores configuration change information that represents configuration information concerning difference between the operational system and a test system of the virtual system; a second virtual machine image storage device that stores second virtual machine images for the virtual machine relating to the difference; and a controller. Thus, by adopting data configuration of the operational system and data configuration of the test system, it becomes possible to easily and smoothly switch the virtual system between the operational system and the test system.

Incidentally, in response to a deployment request of the test system of the specific virtual system, the aforementioned controller activates the virtual machines necessary for the operational system of the specific virtual system in the physical server pool in which the operational system and the test system of the virtual system can be deployed, by using first server configuration data in the configuration information for the operational system of the specific virtual system, which is identified from the configuration information storage device, and a virtual machine image for the operational system of the specific virtual machine, which is identified from the first virtual machine image storage device. In addition, the controller activates a virtual machine to be added to the operational system of the specific virtual system in the physical server pool, by using second server configuration data in the configuration change information for the specific virtual system, which is identified from the configuration change information storage device, and the second virtual machine image for the specific virtual system, which is identified from the second virtual machine image storage device. Then, the controller carries out a setting of the network connecting the activated virtual machines according to network configuration data generated by merging first network setting information between the virtual machines and second network setting information that represents difference on the network between the operational system and the test system of the specific virtual system and is included in the configuration change information. Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer-readable storage medium storing a program for causing a computer to execute a virtual system control process, comprising:
receiving a deployment request for requesting to deploy a test system of a specific virtual system in a physical server pool in which both of operational and test virtual systems can be deployed;
activating a virtual machine necessary for said operational system of said specific virtual system in said physical server pool by using first server configuration data in configuration information for said operational system of said specific virtual system and a first virtual machine image for said operational system of said specific virtual system;
activating a virtual machine to be added to said operational system of said specific virtual system in said physical server pool by using second server configuration data in configuration change information representing configuration information concerning difference between said operational system and said test system of said specific virtual system and a second virtual machine image for said virtual machine relating to said difference; and
carrying out a setting of a network connecting the activated virtual machines according to network configuration data generated by merging first network setting information between said virtual machines in said configuration information for said operational system of said specific virtual system and second network setting information that represents difference on the network between said operational system and said test system of said specific virtual system and is included in said configuration change information.

2. The computer-readable storage medium as set forth in claim 1, further comprising:
receiving a second deployment request for requesting to deploy said operational system of a second virtual system in said physical server pool;
activating second virtual machines necessary for said operational system of said second virtual system in said physical server pool, by using third server configuration data in second configuration information for said operational system of said second virtual system and third virtual machine images for said operational system of said second virtual machine; and
carrying out a setting of a network connecting the activated second virtual machines according to third network setting information in said second configuration information.

3. The computer-readable storage medium as set forth in claim 1, wherein said activating said virtual machine necessary for said operational system comprises:
identifying said configuration information for said operational system of said specific virtual machine relating to said deployment request;
securing first physical machines that can be deployed in said physical server pool according to said first server configuration data included in the identified configuration information; and
identifying said first virtual machine images for said operational system of said specific virtual system, and activating said virtual machines on the secured first physical servers by using the identified first virtual machine images.

4. The computer-readable storage medium as set forth in claim 1, wherein said activating said virtual machine to be added comprises:
identifying said configuration change information for said specific virtual system;
securing second physical servers that can be deployed in said physical server pool according to said second server configuration data included in said configuration change information for said specific virtual system; and
identifying said second virtual machine images for said virtual machines relating to said difference, and activating said virtual machines on the secured second physical servers.

5. The computer-readable storage medium as set forth in claim 3, wherein said identifying said configuration information comprises:
identifying an identifier of said configuration information for said operational system of said specific virtual system relating to said deployment request, from a first management table storing identifiers of said configuration information for said operational system of said virtual system and identifiers of said first virtual machine images; and
reading out said configuration information corresponding to the identified identifier of said configuration information from a configuration information storage device storing said configuration information for said operational system of said virtual system in association with said identifiers of said configuration information.

6. The computer-readable storage medium as set forth in claim 5, wherein said activating said virtual machines on said secured first physical servers comprises:
identifying an identifier of said first virtual machine image for said operational system of said specific virtual system relating to said deployment request from said first management table; and
reading out said first virtual machine image corresponding to the identified identifier of said first virtual machine image from a first virtual machine image storage device storing said first virtual machine images for said operational system of said virtual system in association with said identifiers of said first virtual machine images.

7. The computer-readable storage medium as set forth in claim 4, wherein said identifying said configuration change information for said specific virtual system comprises:
identifying an identifier of said configuration change definition information for said specific virtual system relating to said deployment request from a second management table storing identifiers of said configuration change information of said specific system and identifiers of said second virtual machine images for the virtual machines relating to said difference between said operational system and said test system; and
reading out said configuration change information corresponding to the identified identifier of said configuration change information from a configuration change information storage device storing said configuration change information of said virtual systems in association with said identifiers of said configuration change information.

8. The computer-readable storage medium as set forth in claim 7, wherein said identifying said second virtual machine images comprises:
identifying an identifier of said second virtual machine image for said specific virtual system relating to said deployment request from said second management server; and
reading out said second virtual machine image corresponding to the identified identifier of said second virtual machine image from a second virtual machine image storage device storing said second virtual machine images for the virtual machines relating to the difference between said operational system and said test system of said virtual system in association with said identifiers of said second virtual machine images.

9. The computer-readable storage medium as set forth in claim 1, wherein said carrying out said setting of said network connecting the activated virtual machines comprises:
deleting, from said first network setting information included in said configuration information, items to be deleted among items in said second network setting information included in said configuration change information, and adding to said first network setting information included in said configuration information, items to be added among said items in said second network configuration information included in said configuration change information.

10. A virtual system control method, comprising:
receiving a deployment request for requesting to deploy a test system of a specific virtual system in a physical server pool in which both of operational and test virtual systems can be deployed;
activating a virtual machine necessary for said operational system of said specific virtual system in said physical server pool by using first server configuration data in configuration information for said operational system of said specific virtual system and a first virtual machine image for said operational system of said specific virtual system;
activating a virtual machine to be added to said operational system of said specific virtual system in said physical server pool by using second server configuration data in configuration change information representing configuration information concerning difference between said operational system and said test system of said specific virtual system and a second virtual machine image for said virtual machine relating to said difference; and
carrying out a setting of a network connecting the activated virtual machines according to network configuration data generated by merging first network setting information between said virtual machines in said configuration information for said operational system of said specific virtual system and second network setting information that represents difference on the network between said operational system and said test system of said specific virtual system and is included in said configuration change information.

11. A virtual system control apparatus, comprising:
a configuration information storage device that stores configuration information for operational systems of virtual systems;
a first virtual machine image storage device that stores first virtual machine images for said operational systems of said virtual systems;
a configuration change information storage device that stores configuration change information that represents configuration information concerning difference between said operational system and a test system of said virtual system;
a second virtual machine image storage device that stores second virtual machine images for a virtual machine relating to said difference; and
a controller, and
wherein, in response to a deployment request of said test system of a specific virtual system, said controller activates said first virtual machines necessary for said operational system of said specific virtual system in said physical server pool in which both of said operational system and said test system of said virtual system can be deployed, by using first server configuration data in said configuration information for said operational system of said specific virtual system, which is identified from said configuration information storage device, and a first virtual machine image for said operational system of said specific virtual system, which is identified from said first virtual machine image storage device, and
said controller activates a virtual machine to be added to said operational system of said specific virtual system in said physical server pool, by using second server configuration data in said configuration change information for said specific virtual system, which is identified from said configuration change information storage device, and said second virtual machine image for said specific virtual system, which is identified from said second virtual machine image storage device, and
said controller carries out a setting of a network connecting the activated virtual machines according to network configuration data generated by merging said first network setting information between said virtual machines in said configuration information for the operational system of said specific virtual system and second network setting information, which represents difference on said network between said operational system and said test system of said specific virtual system and is included in said configuration change information.

12. The virtual system control apparatus as set forth in claim 11, wherein, in response to a second deployment request for requesting to deploy said operational system of a second virtual system in said physical server pool, said controller activates second virtual machines necessary for said operational system of said second virtual system in said physical server pool, by using third server configuration data in second configuration information for said operational system of said second virtual system and third virtual machine images for said operational system of said second virtual machine; and
said controller carries out a setting of a network connecting the activated second virtual machines according to third network setting information in said second configuration information.
